(19) United States
(12) Patent Application Publication
(10) Pub. No.: US 2004/0097276 A1
(43) Pub. Date: May 20, 2004

(54) Replaceable housing for a mobile communication device

(76) Inventor: Roger Wright Harmon, Crystal Lake, IL (US)

Correspondence Address: MOTOROLA INC, 600 NORTH US HIGHWAY 45, ROOM AS437, LIBERTYVILLE, IL, 60048-5343, US

(21) Appl. No.: 10/294,328

(22) Filed: Nov. 14, 2002

(51) Int. Cl. H04B 1/38; H04M 1/00

(52) U.S. Cl. 455/575.1; 455/575.4; 455/90.2

(57) ABSTRACT

A replaceable housing for a mobile communication device. The mobile communication device can include an inner module, a cap outer housing and a base outer housing. The inner module can include a first inner module housing, a second inner module housing, and a tongue including a portion of the first inner module housing and a portion of the second inner module housing. The cap outer housing can include a slot along an inner length of the cap outer housing. The base outer housing can also include a slot along an inner length of the base outer housing. The tongue can include a portion of the first inner module housing and a portion of the second inner module housing.

### CROSS-REFERENCE TO RELATED APPLICATIONS

This application is related to patent application entitled “Apparatus and Method for Antenna Attachment,” Motorola case number CS20025RL, which is herein incorporated by reference, filed on Nov. 5, 2002, and commonly assigned to the assignee of the present application.

### BACKGROUND OF THE INVENTION

1. Field of Invention

The present invention is directed to a replaceable housing for a mobile communication device. In particular, the present invention is directed to a postponable housing including two outer housings for a mobile communication device.

2. Description of Related Art

Presently, there are many different exterior styles of mobile communication devices. There are many different styles because different users may have different tastes in desired mobile communication device exterior styles. There are also many different styles because different carriers may desire different styles to differentiate their mobile communication devices from mobile communication devices of other carriers. Unfortunately, mobile communication device exteriors are not easily interchangeable. For example, mobile communication device providers may attempt to engage in postponement of adding exterior housings to mobile communication devices. In particular, mobile communication device providers may postpone the addition of the housings and other features until late in the design and/or late in the manufacturing process. Unfortunately, attempts at exterior interchangeability is often difficult to achieve. For example, exterior interchangeability can often result in compromised structural integrity. In particular, exterior and interior connections may easily break and expose the interior components of a mobile communication device to damage.

Thus, to provide for different desires for different mobile communication device exteriors, mobile communication device providers may produce many different mobile communication devices. Unfortunately, it can be costly and time consuming to design completely different mobile communication devices for different consumers and different service providers.

Thus, there is a need for an improved mobile communication device housing that easily provides for removal and replacement. There is also a need for an improved mobile communication device that provides for improved structural support. These and other needs are provided for by the present invention.

### SUMMARY OF THE INVENTION

The invention provides a replaceable housing for a mobile communication device. The mobile communication device can include an inner module, a cap outer housing and a base outer housing. The inner module can include a first inner module housing, a second inner module housing, and a tongue including a portion of the first inner module housing and a portion of the second inner module housing. The cap outer housing can include a slot along an inner length of the cap outer housing. The base outer housing can also include a slot along an inner length of the base outer housing. The tongue can include a portion of the first inner module housing and a portion of the second inner module housing. The inner module can include an outer peripheral edge including the tongue.

The slot along the inner length of the cap outer housing may be coupled to the tongue and the slot along the inner length of the base outer housing may be coupled to the tongue. The cap outer housing may be removably coupled to the inner module housing. The base outer housing may be removably coupled to the inner module housing. The slot can compress the first inner module housing against the second inner module housing.

The mobile communication device can also include a printed circuit board coupled to the first inner module housing and coupled to the second inner module housing. The tongue can include a section of the printed circuit board. The base outer housing can include a first base outer housing side wall including the slot, the first base outer housing side wall also including a first snap arm. The base outer housing can further include a second base outer housing side wall including the slot, the second base outer housing side wall being opposed to the first base outer housing side wall, the second base outer housing side wall including a second snap arm. The cap outer housing can include an antenna.

According to another embodiment, the present invention provides a mobile communication device having an inner module including a speaker section including a speaker and a microphone section including a microphone. The mobile communication device can also have a cap outer housing including opposed cap outer housing side walls, each cap outer housing side wall including a slot along an inner length of the cap outer housing side wall, the cap outer housing covering a portion of the speaker section of the inner module. The mobile communication device can further include a base outer housing separate from the cap outer housing and covering a portion of a microphone section of the inner module. The base outer housing can include opposed base outer housing side walls, each base outer housing side wall including a slot along the inner length of the base outer housing side wall.

The cap outer housing can be removably coupled to the inner module and the base outer housing can be removably coupled to the inner module. The inner module can include a tongue coupled to the slot of the cap outer housing and coupled to the slot of the base outer housing. The inner module can include a first inner module housing and a second inner module housing. The tongue can include a portion of the first inner module housing and a portion of the second inner module housing. The inner module can further include a printed circuit board. The tongue can further include a portion of the printed circuit board.

The inner module can also include a first inner module housing and a second inner module housing. The first inner module housing can be coupled to the cap outer housing along a length of the slot along the inner length of the cap outer housing. The second inner module housing can be coupled to the cap outer housing along a length of the slot along the inner length of the cap outer housing. The first inner module housing can be coupled to the base outer housing along a length of the slot along the inner length of the cap outer housing. The second inner module housing can be coupled to the base outer housing along a length of the slot along the inner length of the cap outer housing.

The mobile communication device can also include a first snap arm located at an end of a first base outer housing side wall and a second snap arm located at an end of an opposed second base outer housing side wall. The cap outer housing can include a button snap arm. The inner module can include a display section. The cap outer housing can include a transparent section configured to cover a portion of the display section. The cap outer housing can also include an aperture located at a location of the speaker in the speaker section. The microphone section can include a battery and the base outer housing can be configured to cover the battery. The cap outer housing may include an antenna. The mobile communication device may include a replaceable keypad.

According to another embodiment, the present invention provides a mobile communication device. The mobile communication device can include an inner module having a peripheral frame edge, the inner module also including a first frame section and a second frame section. The inner module can further include a protruding tongue formed on the peripheral frame edge, the protruding tongue extending outwardly away from the peripheral frame edge in a first direction. The protruding tongue can have a head remote from the peripheral frame edge and a neck extending from the head, the neck having sides, where the sides extend in the first direction from the peripheral frame edge to the head. The mobile communication device can also include a first housing having a first inner housing section, the first housing configured to cover the first frame section. The first housing can include a groove formed on the first inner housing section and extending into the first housing from the first inner housing section in the first direction to form a cavity. The groove can be defined by a mouth at the first inner housing section with two sides that extend inwardly from the first inner housing section in the first direction toward a throat. The mobile communication device can further include a second housing having a second inner housing section, the second housing configured to cover the second section. The second housing can have a groove formed on the second inner housing section and extending in to the second housing from the second inner housing section in the first direction to form a cavity, the groove defined by a mouth at the second inner housing section with two sides that extend inwardly from the second inner housing section in the first direction toward a throat. The first housing and the second housing can be configured to combine to cover a substantial portion of the entire peripheral frame edge. The inner module can further include a first inner module housing, a first neck side of the neck sides including a portion of the first inner module housing. The inner module can also include a second inner module housing, a second neck side opposite of the first neck side of the neck sides including a portion of the second inner module housing.

Thus, among other benefits, the present invention can maintain high structural strength of the mobile communication device while providing for replacement housings. The present invention also provides for high design flexibility. The present invention can further provide for ease of customer interchangeability of mobile communication device housings. The present can additionally provide for reducing the volume and size of a mobile communication device with postponable housings. These and many other benefits are provided for by the present invention.

### BRIEF DESCRIPTION OF THE DRAWINGS

The preferred embodiments of the present invention will be described with reference to the following figures, wherein like numerals designate like elements, and wherein:

FIG. 1 is an exemplary isometric view of a mobile communication device according to a preferred embodiment;

FIG. 2 is an exemplary isometric view of the inner module housing according to a preferred embodiment;

FIG. 3 is an exemplary isometric view of an assembled mobile communication device according to a first embodiment;

FIG. 4 is an exemplary cross sectional view of the mobile communication device;

FIG. 5 is an exemplary isometric view of the base outer housing according to a preferred embodiment;

FIG. 6 is an exemplary isometric view of the cap outer housing according to one embodiment;

FIG. 7 is an exemplary isometric view of the cap outer housing according to a second embodiment;

FIG. 8 is an exemplary isometric view of assembled mobile communication device according to a second embodiment;

FIG. 9 is an exemplary view of the tongue and groove combination of the present invention according to a first embodiment;

FIG. 10 is an exemplary view of a tongue according to a second embodiment; and

FIG. 11 is an exemplary view of a tongue according to a third embodiment.

### DETAILED DESCRIPTION OF PREFERRED EMBODIMENTS

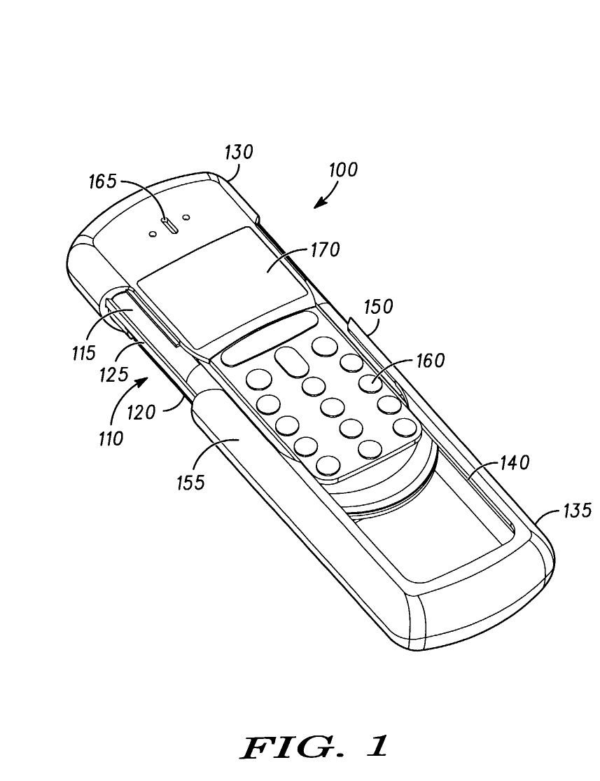

FIG. 1 is an exemplary isometric view of a mobile communication device 100 according to a preferred embodiment. The mobile communication device 100 can include an inner module 110, a cap outer housing 130, and a base outer housing 135. The inner module 110 can include a first inner module housing 115, a second inner module housing 120, a tongue 125, and a keypad 160. The inner module 110 can also contain most electrical and mechanical components for the operation of the mobile communication device 100. The keypad 160 may be replaceable and/or may be part of the base outer housing 135. The cap outer housing 130 can include an aperture 165 for a speaker, and a section 170 for a display. The section 170 for the display may be an aperture, may be a transparent section, or any other section useful for a display. The base outer housing 135 can include a slot or groove 140, and snap arms 150 and 155.

In operation, the tongue 125 and groove 140 can act as locate points for the outer housings 130 and 135. The tongue 125 and groove 140 can also lock the inner module housings 115 and 120 together to provide structural rigidity for the fully assembled mobile communication device 100. The base outer housing 135 can cover the outer surface and bottom of the mobile communication device 100. The base outer housing 135 can additionally cover a removable battery that may be located in the back of the mobile communication device 100. The aperture 165 provides a pass through for a speaker located on the inner module 110. The display section 170 can provide a viewing area for a display on the inner module 110. Also, the cap outer housing 130 can include an antenna, such as a patch antenna, or any other antenna for the mobile communication device 100. Additionally the cap outer housing 130 and the base outer housing 135 are slidably coupled to the inner module 110 by means of the tongue 125 and the groove 140. Furthermore, the snap arms 150 and 155 can operate to secure the outer housings 130 and 135 to the inner module 110. For example, the snap arms 150 and 155 may contain clips for securing the outer housings 130 and 135 to the inner module 110.

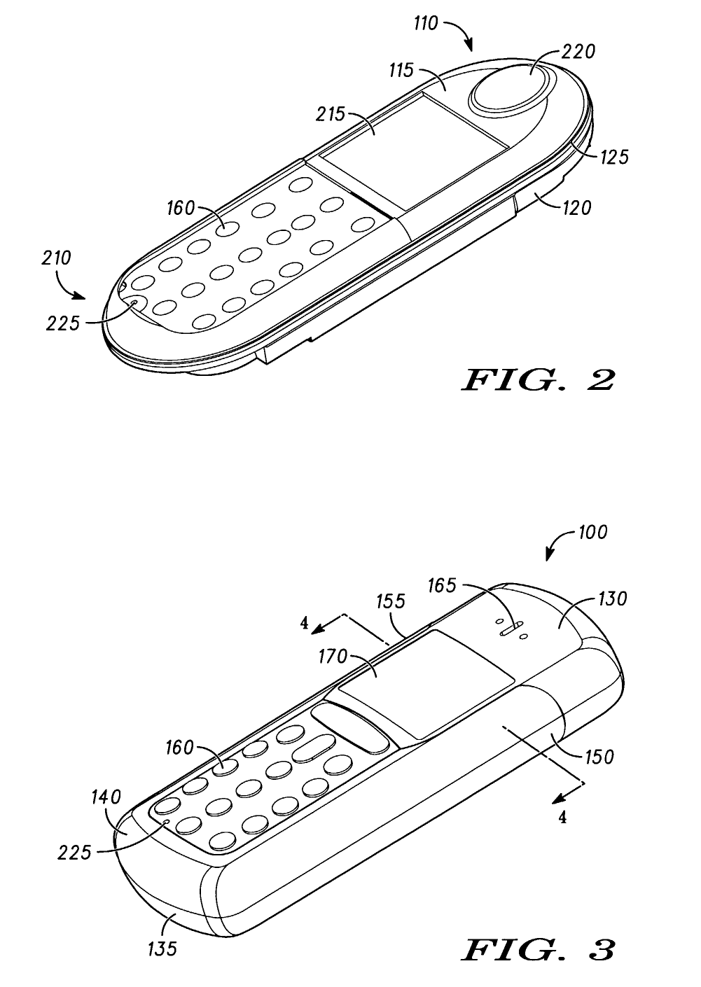

FIG. 2 is an exemplary isometric view of the inner module 110 according to a preferred embodiment. The inner module 110 can include an outer peripheral edge 210 that surrounds an outer side edge of the inner module 110. The tongue 125 can substantially surround the outer peripheral edge 210. For example, the tongue 125 may only exist on part of the outer peripheral edge 210, for space saving reasons, to accommodate accessory jacks, or for other reasons. The inner module 110 can also include a display 215, a speaker 220, and a microphone 225.

In operation, the display 215 can display visual information on the mobile communication device 100. The speaker 220 can output audible information from the mobile communication device 100. Also, the microphone 225 can provide for input of audible information to the mobile communication device 100. Furthermore, the keypad 160 can provide for additional input information to the mobile communication device 100.

FIG. 3 is an exemplary isometric view of an assembled mobile communication device 100 according to a preferred embodiment. For example, the assembled mobile communication device 100 may have a box shape. When assembled, the outer housings 130 and 135 operate to cover portions of the inner module 110. For example, the cap outer housing 130 may cover a portion of the speaker section 220 and the display section 170 of the inner module 110. Also, the base outer housing 135 may cover a portion of the microphone section 225 and the keypad section 160 of the inner module 110. For example, the microphone section 225 may include approximately a lower half of the inner module 110. The snap arms 150 and 155 can operate to lock the base outer housing 135 in place. In doing so, the snap arms 150 and 155 can be coupled to the cap outer housing 130 to secure the cap outer housing 130 in place. The cap outer housing 130 may include approximately an upper half of the inner module 110.

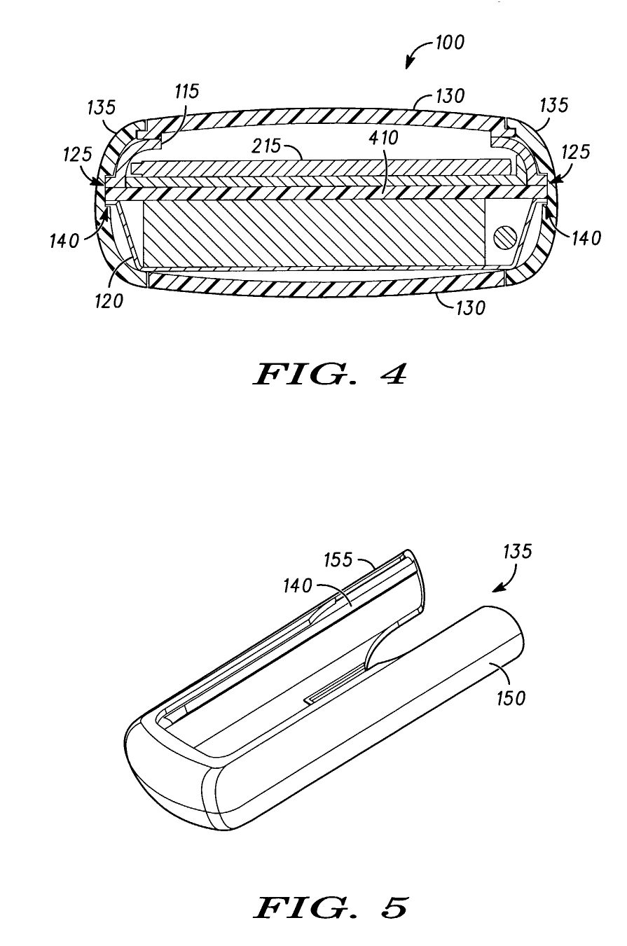

FIG. 4 is an exemplary cross sectional view of the mobile communication device 100 through section 4-4 of FIG. 3. The mobile communication device 100 may further include a printed circuit board (PCB) 410. The PCB 410 may include electronic components of the mobile communication device 100. As illustrated, the first inner module housing 115 may comprise plastic feet for supporting the outer housings 130 and 135 and for protecting components of the inner module 110. Also, the second inner module housing 120 may include a metal stamping for containing rear components of the mobile communication device 100 such as a battery. The tongue 125 can include portions of the first inner module housing 115, the second inner module housing 120, and the PCB 410. The groove 140 can then provide a secure fit for securing the portions of the first inner module housing 115, the second inner module housing 120, and the PCB 410.

FIG. 5 is an exemplary isometric view of the base outer housing 135 according to a preferred embodiment. As shown, the groove 140 can run down a substantial length of the inner sides of the base outer housing 135. Also, portions of the groove 140 may run down only a portion of the sides of the base outer housing 135. For example, the groove 140 may only exist in the snap arms 150 and 155 of the base outer housing 135. Furthermore, the groove 140 may run the entire length of the inside of the base outer housing 135.

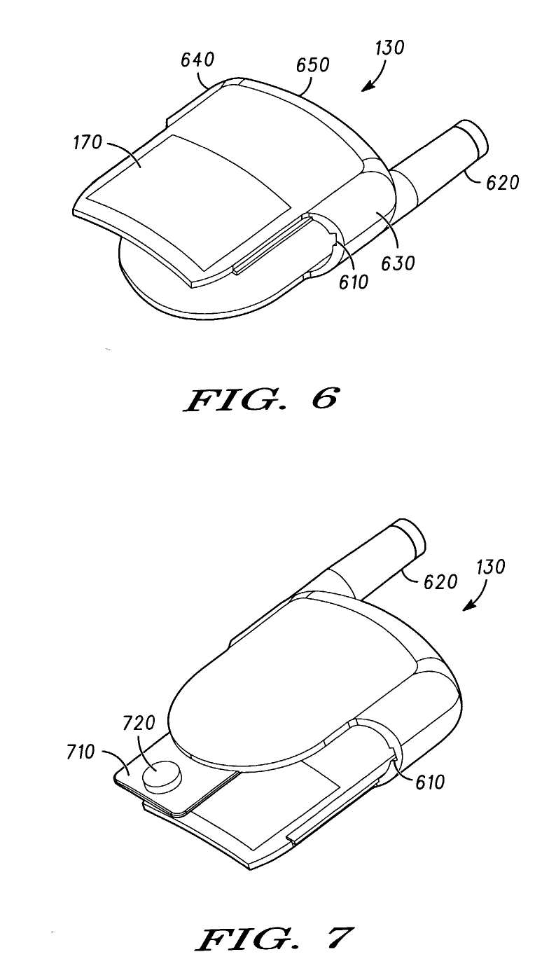

FIG. 6 is an exemplary isometric view of the cap outer housing 130 according to one embodiment. The cap outer housing 130 can include an antenna 620 such as a stubby antenna, a whip antenna, a retractable antenna, or a patch antenna such as a planar inverted-F antenna. The groove 140 can run into the cap as the cap groove 610. The cap groove 610 may run a substantial length, a partial length, or the entire interior of an interior section along the side walls 630 and 640 and the top 650 of the cap outer housing 130.

FIG. 7 is an exemplary isometric view of the cap outer housing 130 according to another embodiment. The cap outer housing 130 can include a button snap arm 710. The button snap arm 710 may be used to secure the cap outer housing 130 to the inner module 110 or the base outer housing 135. For example, the button snap arm 710 may include a button 720 for snapping the button snap arm 710 to the base outer housing 135. The button snap arm 710 may be used with other securing features to provide a secure fit of the outer housings 130 and 135 to the mobile communication device 100.

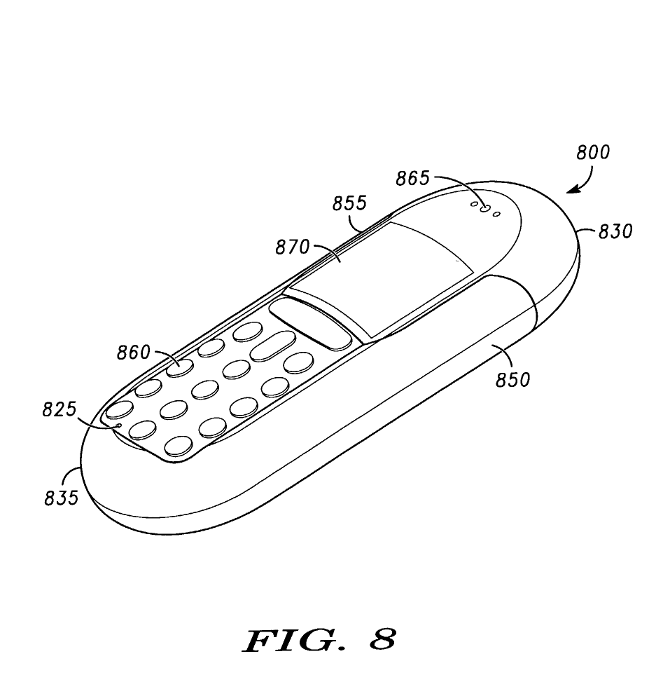

FIG. 8 is an exemplary isometric view of assembled mobile communication device 800 according to another embodiment. The mobile communication device 800 can include all of the components of the mobile communication device 100. For example, the mobile communication device 800 can include a microphone 825, a base outer housing 835, a keypad 860, snap arms 850 and 855, a cap outer housing 830, a display section 870, and a speaker section 865. As illustrated, the mobile communication device 800 may take the form of a pill shaped mobile communication device. Various other shapes of mobile communication devices may also be utilized for the mobile communication device 800 without departing from the spirit of the present invention.

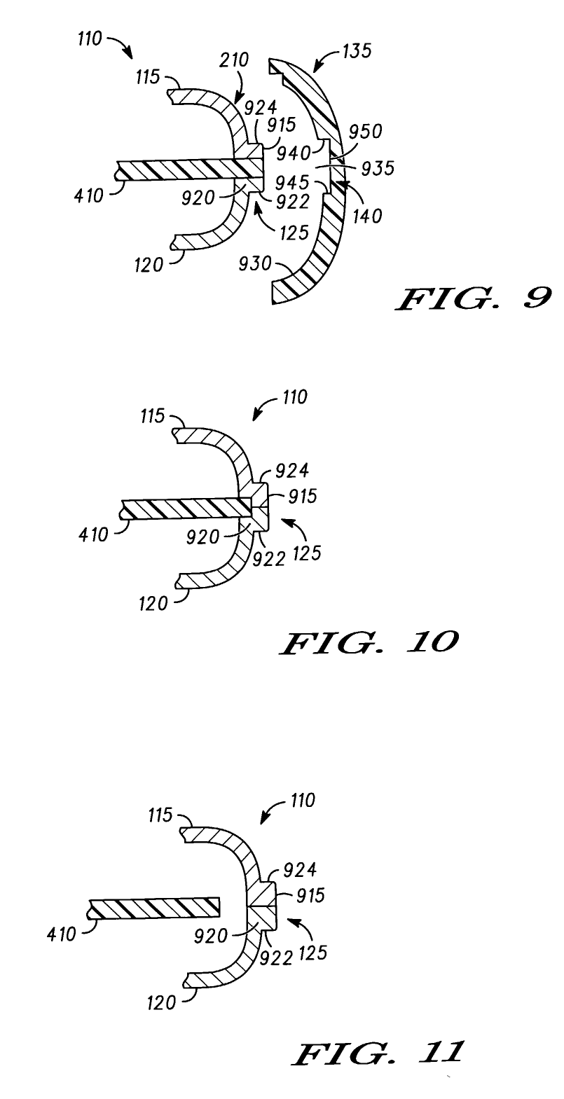

FIG. 9 is an exemplary view of the tongue 125 and groove 140 combination of the present invention according to a first embodiment. The inner module 110 can include a peripheral frame edge 210. The peripheral frame edge 210 can include a protruding tongue 125 formed on the peripheral frame edge 210. The protruding tongue 125 extends outwardly away from the peripheral frame edge 210. The protruding tongue 125 can include a head 915 remote from the peripheral frame edge 210 and a neck 920 extending from the head 915. The neck has sides 922 and 924 that extend in the first direction from the peripheral frame edge 210 to the head 915. The base outer housing 135 includes an inner housing section 930. A groove 140 is formed on an inner housing section 930 and extends into the base outer housing 135 in the first direction to form a cavity, the groove 140 defined by a mouth 935 at the inner housing section 930 with two sides 940 and 945 that extend inwardly from the inner housing section 930 in the first direction toward a throat 950. Various modifications are possible. For example, the neck sides 922 and 924 may taper to a pointed head 915 form a triangular tongue. Also, the neck sides 922 and 924 may curve to a rounded head 915 to form a curved tongue. The cap outer housing 130 can couple with the inner module 110 in a similar manner. The base outer housing 135 and the cap outer housing 130 can combine to cover a substantial portion of the entire peripheral frame edge 210.

One neck side 924 can include a portion of the first inner module housing 115 and the other neck side 922 can include a portion of the second inner module housing 120. The neck 920 may further include a portion of the PCB 410. Thus, when the inner module 110 is coupled with the base outer housing 135, the groove 140 can press together the portions of the first inner module housing 115, the second inner module housing 120, and the PCB 410 for increased rigidity.

FIG. 10 is an exemplary view of a tongue 125 according to a second embodiment. According to this embodiment, one neck side 924 can include a portion of the first inner module housing 115 and the other neck side 922 can include a portion of the second inner module housing 120. The neck 920 may further include a portion of the PCB 410. However, according to this embodiment, the portion of the PCB 410 may not extend through the tongue 125 to the head 915.

FIG. 11 is an exemplary view of a tongue 125 according to a third embodiment. According to this embodiment, one neck side 924 can include a portion of the first inner module housing 115 and the other neck side 922 can include a portion of the second inner module housing 120. However, the neck 920 does not include a portion of the PCB 410.

While this invention has been described with specific embodiments thereof, it is evident that many alternatives, modifications, and variations will be apparent to those skilled in the art. For example, various components of the embodiments may be interchanged, added, or substituted in the other embodiments. Accordingly, the preferred embodiments of the invention as set forth herein are intended to be illustrative, not limiting. Various changes may be made without departing from the spirit and scope of the invention.

What is claimed is:

1. A mobile communication device comprising:
an inner module including
a first inner module housing,
a second inner module housing, and
a tongue including a portion of the first inner module housing and a portion of the second inner module housing;
a cap outer housing including a slot along an inner length of the cap outer housing; and
a base outer housing including a slot along an inner length of the base outer housing.

2. The mobile communication device according to claim 1,
wherein the inner module further includes an outer peripheral edge including the tongue.

3. The mobile communication device according to claim 2,
wherein the tongue includes a portion of the first inner module housing and a portion of the second inner module housing.

4. The mobile communication device according to claim 1,
wherein the slot along the inner length of the cap outer housing is coupled to the tongue, and
wherein the slot along the inner length of the base outer housing is coupled to the tongue.

5. The mobile communication device according to claim 4,
wherein the cap outer housing is removably coupled to the inner module housing.

6. The mobile communication device according to claim 5,
wherein the base outer housing is removably coupled to the inner module housing.

7. The mobile communication device according to claim 4,
wherein the slot compresses the first inner module housing against the second inner module housing.

8. The mobile communication device according to claim 1, further comprising:
a printed circuit board coupled to the first inner module housing and coupled to the second inner module housing,
wherein the tongue further comprises a section of the printed circuit board.

9. The mobile communication device according to claim 1,
wherein the base outer housing comprises
a first base outer housing side wall including the slot, the first base outer housing side wall also including a first snap arm, and
a second base outer housing side wall including the slot, the second base outer housing side wall being opposed to the first base outer housing side wall, the second base outer housing side wall including a second snap arm.

10. The mobile communication device according to claim 1,
wherein the cap outer housing includes an antenna.

11. A mobile communication device comprising:
an inner module including
a speaker section including a speaker, and
a microphone section including a microphone;
a cap outer housing including opposed cap outer housing side walls, each cap outer housing side wall including a slot along an inner length of the cap outer housing side wall, the cap outer housing covering a portion of the speaker section of the inner module; and
a base outer housing separate from the cap outer housing, the base outer housing including opposed base outer housing side walls, each base outer housing side wall including a slot along the inner length of the base outer housing side wall, the base outer housing covering a portion of a microphone section of the inner module.

12. The mobile communication device according to claim 11,
wherein the cap outer housing is removably coupled to the inner module, and
wherein the base outer housing is removably coupled to the inner module.

13. The mobile communication device according to claim 11, wherein the inner module further comprises a tongue coupled to the slot of the cap outer housing and coupled to the slot of the base outer housing.

14. The mobile communication device according to claim 13,
wherein the inner module further comprises
a first inner module housing, and
a second inner module housing, and
wherein the tongue comprises a portion of the first inner module housing and a portion of the second inner module housing.

15. The mobile communication device according to claim 14,
wherein the inner module further comprises
a printed circuit board, and
wherein the tongue further comprises a portion of the printed circuit board.

16. The mobile communication device according to claim 13,
wherein the inner module further comprises
a first inner module housing, and
a second inner module housing,
wherein the first inner module housing is coupled to the cap outer housing along a length of the slot along the inner length of the cap outer housing, and
wherein the second inner module housing is coupled to the cap outer housing along a length of the slot along the inner length of the cap outer housing.

17. The mobile communication device according to claim 16,
wherein the first inner module housing is coupled to the base outer housing along a length of the slot along the inner length of the cap outer housing, and
wherein the second inner module housing is coupled to the base outer housing along a length of the slot along the inner length of the cap outer housing.

18. The mobile communication device according to claim 11, further comprising:
a first snap arm located at an end of a first base outer housing side wall; and
a second snap arm located at an end of an opposed second base outer housing side wall.

19. The mobile communication device according to claim 11,
wherein the cap outer housing includes a button snap arm.

20. The mobile communication device according to claim 11,
wherein the inner module further includes a display section, and
wherein the cap outer housing further includes a transparent section configured to cover a portion of the display section.

21. The mobile communication device according to claim 11,
wherein the cap outer housing further includes an aperture located at a location of the speaker in the speaker section.

22. The mobile communication device according to claim 11,
wherein the microphone section further includes a battery, and
wherein the base outer housing is configured to cover the battery.

23. The mobile communication device according to claim 11,
wherein the cap outer housing includes an antenna.

24. The mobile communication device according to claim 11, further comprising a replaceable keypad.

25. A mobile communication device comprising:
an inner module including a peripheral frame edge, the inner module also including a first frame section and a second frame section;
a protruding tongue formed on the peripheral frame edge, the protruding tongue extending outwardly away from the peripheral frame edge in a first direction, said protruding tongue comprising:
a head remote from the peripheral frame edge, and
a neck extending from the head, the neck having sides, wherein the sides extend in the first direction from the peripheral frame edge to the head;
a first housing having a first inner housing section, the first housing configured to cover the first frame section;
a groove formed on the first inner housing section and extending into the first housing from the first inner housing section in the first direction to form a cavity, the groove defined by a mouth at the first inner housing section with two sides that extend inwardly from the first inner housing section in the first direction toward a throat;
a second housing having a second inner housing section, the second housing configured to cover the second section;
a groove formed on the second inner housing section and extending in to the second housing from the second inner housing section in the first direction to form a cavity, the groove defined by a mouth at the second inner housing section with two sides that extend inwardly from the second inner housing section in the first direction toward a throat.

26. The mobile communication device according to claim 25,
wherein the first housing and the second housing are configured to combine to cover a substantial portion of the entire peripheral frame edge.

27. The mobile communication device according to claim 25,
wherein the inner module further comprises:
a first inner module housing, a first neck side of the neck sides including a portion of the first inner module housing, and
a second inner module housing, a second neck side opposite of the first neck side of the neck sides including a portion of the second inner module housing.
